(19) United States
(12) Patent Application Publication
(10) Pub. No.: US 2012/0060863 A1
(43) Pub. Date: Mar. 15, 2012

(54) METHOD AND APPARATUS FOR WASHING A VEHICLE

(75) Inventors: André Speckmaier, Wuestenrot (DE); Claus Heid, Stuttgart (DE); Rainer Fischer, Muehlacker (DE); Bruno Mettang, Schwaikheim (DE)

(73) Assignee: Alfred Kaercher GmbH & Co. KG, Winnenden (DE)

(21) Appl. No.: 13/225,808

(22) Filed: Sep. 6, 2011

(30) Foreign Application Priority Data
Sep. 10, 2010 (EP) 10 176 173.2

(51) Int. Cl. B08B 1/02; B08B 3/00

(52) U.S. Cl. 134/6; 134/123; 134/56 R

(57) ABSTRACT

The invention relates to a method for washing a vehicle at a vehicle wash facility. At least one wash tool is moved along the vehicle as a function of the contour of the vehicle. In order for effective cleaning of the vehicle to be achieved even if the latter has a complicated contour, the invention proposes that at least one wash tool be moved along the vehicle during a reference run, the movement of the wash tool being controlled manually along at least a partial area of the vehicle, and that the contour of at least the vehicle area in which the movement of the wash tool is controlled manually be stored in the form of contour data on a storage medium, and that the stored contour data be used in a subsequent washing operation in order to control the same vehicle wash facility or a vehicle wash facility of identical construction. Furthermore, a vehicle wash facility is proposed for carrying out the method.

The present disclosure relates to the subject matter disclosed in European Patent Application No. 10 176 173.2 filed on Sep. 10, 2010, which is incorporated herein by reference in its entirety and for all purposes.

### BACKGROUND OF THE INVENTION

The invention relates to a method for washing a vehicle by means of a vehicle wash facility, wherein at least one wash tool is moved along the vehicle as a function of the contour of the vehicle.

The invention further relates to a vehicle wash facility for carrying out the method comprising at least one wash tool movable along the vehicle as a function of the contour of the vehicle.

Vehicle wash facilities are known in the form of wash lines and gantry-type wash facilities. In wash lines, the vehicle passes through different washing stations equipped with wash tools which can approach the surface of the vehicle. Wash tools may be, for example, rotating wash brushes or nozzle beams with a number of nozzles by means of which a jet of cleaning agent can be applied to the area to be cleaned. Gantry-type wash facilities utilize a gantry which is moved along the vehicle in a direction of advance motion and holds at least one wash tool. The wash tool can be moved along the vehicle as a function of the vehicle's contour.

The contour of a vehicle may be detected before or during a washing operation with the aid of suitable sensors, for example by means of a light barrier. With a wash brush that is adjustable perpendicularly to the direction of advance motion, the motor current of the wash brush's electric motor may be detected. The motor current has a predetermined value at a distance from the vehicle that is optimal for cleaning the vehicle. When the wash brush encounters an obstacle, which in the case of a vehicle may be, for example, a mirror projecting from the vehicle's surface, the motor current is caused to rise. Such a rise can be detected by a current sensor, whose sensor signal is transmitted to a control device by means of which the wash brush can be moved in a direction perpendicular to the direction of advance motion. In the case of an obstacle, the wash brush is moved to a greater distance from the vehicle, so that the motor current returns to its original value and the brush is manoeuvred around the obstacle. The contour of the vehicle may be detected in the form of the position of the wash brush relative to a predetermined reference plane at a predetermined motor current.

Moving a wash tool as a function of the contour of the vehicle to be cleaned has proved successful in particular at cleaning passenger automobiles. However, problems may arise where the contour of the vehicle has projections or undercuts, which can often be detected only with the greatest difficulty or not at all. These problems arise, for example, in the case of commercial vehicles with additional attachments or superstructures whose contour often cannot be completely detected by the sensors.

It is an object of the present invention to provide a method for washing a vehicle of the type mentioned at the outset as well as a vehicle wash facility for carrying out the method which allows vehicles to be cleaned effectively even if they have a complicated contour.

### SUMMARY OF THE INVENTION

This object is achieved, in accordance with the invention, in a method of the generic type, in that at least one wash tool is moved along the vehicle during a reference run, the movement of the wash tool being controlled manually along at least a partial area of the vehicle, and in that the contour of at least the vehicle area in which the movement of the wash tool is controlled manually is stored in the form of contour data on a storage medium, and in that the stored contour data is used in a subsequent washing operation in order to control the same vehicle wash facility or a vehicle wash facility of identical construction, in particular to control the movement of the wash tool.

In the method according to the invention, at least one wash tool is moved along the vehicle to be washed as a function of the vehicle's contour. The movement of the wash tool is controlled manually along at least a partial area of the vehicle during a reference run. The user may manually input appropriate control commands into an input device of the vehicle wash facility. This makes it possible for the wash tool to be manoeuvred for example around overhangs, additional attachments or superstructures of the vehicle to be cleaned. With manual control of the wash tool, the contour may be detected in the form of the position of the wash tool relative to a reference plane as a function of the advance motion of the wash tool. Otherwise, the contour may be largely detected automatically by means of sensors, as is known in the prior art, for example by detecting the motor current of the electric motor of the wash tool and the position of the wash tool relative to a reference plane.

At least the contour of those vehicle areas in which the user controls the wash tool manually is stored. For areas of the vehicle in which the vehicle's contour may be detected in a simple manner by means of sensors, the contour need not necessarily be stored, since it can be readily re-detected for every washing operation and used for controlling the vehicle wash facility, in particular for controlling the wash tool. For areas of the vehicle in which automatic contour detection by means of sensors can be achieved only with difficulty and therefore with a considerable expenditure of time, or cannot be achieved at all, and in which the wash tool is therefore controlled manually, the contour is stored on the storage medium and re-used for subsequent washing operations at the same vehicle wash facility or a vehicle wash facility of identical construction.

Storing the contour of at least those vehicle areas along which the wash tool is controlled manually is advantageous in that the manual control need only be performed during a single reference run. Subsequent washing operations can then make use of the stored contour in order to effect control.

The contour can be stored permanently, so that washing operations occurring at longer intervals can also be carried out using the stored contour.

In the method in accordance with the invention, at least the contour of those vehicle areas along which the movement of the wash tool is controlled manually during the reference run is stored. However, it is particularly advantageous for the contour of the entire vehicle to be stored on the storage medium and used to control the same vehicle wash facility or a vehicle wash facility of identical construction during subsequent washing operations. In this way, the complete contour need be detected only once. This has the advantage of making it possible for subsequent washing operations to be completed within a shorter period of time.

The contour data stored on the storage medium is made available to any washing operation applied on vehicles having the stored contour. For example, vehicles with special superstructures whose contours can be detected only with the greatest difficulty can thereby be cleaned within a shorter period of time. Furthermore, if the contour data is already available for subsequent washing operations, it is possible to selectively adapt the use of the wash tools to the specific contour with the objective of cleaning the vehicle extensively within a short period of time and with the least possible expenditure of energy.

Provision may be made for the movement of at least one wash tool to be controlled manually along the entire vehicle during the reference run, thereby detecting the contour of the vehicle. This procedure is recommendable in particular in situations where the vehicle along its entire length has a contour that is difficult to detect automatically.

In many instances, however, it is sufficient, during the reference run, to control the movement of the wash tool manually only in a partial area of the vehicle, while the movement of the wash tool along the remaining areas of the vehicle is sensor-controlled. By way of example, it is possible for the movement of a rotating roof brush or a horizontal nozzle beam with a plurality of nozzles to be automatic, on the basis of sensor data, in the area of the engine hood of the vehicle and/or along the roof and/or along the vehicle rear, while the movement of the roof brush or the vertical nozzle beam, for example in the area of transition between the windshield and the vehicle roof, or along a partial area of the roof having arranged thereon a vehicle superstructure of complicated contour, is controlled manually. At least the contour of the vehicle areas in which the wash tool has been controlled manually can then be stored on the storage medium and used for subsequent washing operations, in particular for controlling the wash tool.

Preferably, the contour data is stored on a portable storage medium such as a memory card, USB stick or transponder. Such portable storage media may be carried along with the vehicle that is to be cleaned. In a subsequent washing operation, the portable storage medium may be read using a data reading device of a vehicle wash facility, so that the contour data may be used to control for example the movement of the wash tools without the user having to control at least one wash tool manually again along at least a partial area of the vehicle.

In particular, it may be provided for the storage medium to be read in a touchless manner, for example via a radio link. By way of example, this enables the use of what is known as an RFID (radio frequency identification) tag. The need for touch-type reading of the storage medium can thereby be eliminated. This, in turn, simplifies the washing operation.

In a preferred embodiment of the invention, the stored contour data is uniquely assigned to the vehicle, or a class of vehicles, having the stored contour by means of an identification code. This procedure is recommendable in particular in situations where the contour data is stored on a stationary storage medium, in particular a storage medium arranged at the vehicle wash facility. In a subsequent washing operation, the user may input the identification code assigned to the stored contour data of the vehicle, or class of vehicles, to be cleaned and having the stored contour, using an input device of the vehicle wash facility. The assigned contour data can then be read from the storage medium on the basis of the identification code. The storage medium may, for example, be a read-only memory that cooperates with a control device of the vehicle wash facility. Assigning an identification code has, for example, the advantage of enabling a plurality of vehicles having the same difficult-to-detect contour in a particular partial area thereof to be washed in a simple manner and within a short period of time. For one of these vehicles, at least one wash tool is controlled manually in the area of the difficult-to-detect contour during a reference run. In the following, this area is also referred to as a “manual control area”. The contour data of the manual control area is stored and assigned an identification code. Subsequent washing operations of vehicles which, while they may well have different contours in different partial areas thereof, still have the same difficult-to-detect contour in a certain partial area thereof can then be washed using the contour data assigned to the identification code. For example, this makes it possible to wash the vehicles of a vehicle fleet, all of which have the same roof superstructure whose contour is difficult to detect and therefore stored with an identification code assigned thereto.

As has been mentioned before, the contour data is detected during a reference run in which at least one wash tool is moved along the vehicle. The reference run may be carried out prior to a washing operation.

It is particularly advantageous for the reference run to be performed during a washing operation. This reduces the time required for overall cleaning of the vehicle.

A particularly preferred embodiment of the method in accordance with the invention not only stores, on the storage medium, the contour data of at least the manual control area, but also stores, on the storage medium, cleaning process specific data of least one wash tool, this being used in a subsequent washing operation in order to control a vehicle wash facility. The data can be detected and stored during the reference run or also during a first washing operation and is then available for use in subsequent washing operations in order to effect control. This makes it possible, during the reference run and/or during a first washing operation, to adjust the control of the wash tools manually and optimally to the vehicle to be cleaned, in particular to the contour thereof. In a subsequent washing operation, it is then possible for not only the contour data but also further data that influences the washing operation to be read from the storage medium and used for controlling the same vehicle wash facility or a vehicle wash facility of identical construction.

By way of example, the pressure of at least one rotating wash brush that is exerted by the latter on the vehicle may be detected and stored during the reference run or also during a washing operation, so that in a subsequent washing operation the stored contact pressure of the rotating wash brush is available for controlling the same.

Alternatively or additionally, it is, for example, possible to detect the intensity of a jet of cleaning agent ejected from the nozzles of a nozzle beam, i.e. it is possible to detect and store the consumption of cleaning agent per unit time. The consumption data stored can then be used in a subsequent washing operation in order to effect control.

It may also be provided for the user to customize a first washing operation, for example by excluding individual vehicle areas from cleaning or by cleaning individual vehicle areas, or the whole vehicle, several times using a particular wash tool. The sequence of the cleaning program can be stored on the storage medium and is available in a subsequent washing operation in order to control the same vehicle wash facility or a vehicle wash facility of identical construction.

In a particularly preferred embodiment of the method in accordance with the invention, the speed of at least one wash tool relative to the vehicle is detected and the detected speed is stored on the storage medium and used in a subsequent washing operation in order to effect control, in particular control of the movement of the wash tool. The user may manually decelerate or accelerate the speed of the wash tool relative to the vehicle in individual areas of the vehicle. By way of example, the speed may be reduced in very heavily soiled areas or increased in areas of particularly simple contour. With such an embodiment, the speed is also stored on the storage medium, so that it can be used in a subsequent washing operation in order to effect control.

As mentioned at the outset, the invention also relates to a vehicle wash facility for carrying out the method described above. The object mentioned at the outset is achieved in a vehicle wash facility of the generic type in that at least one wash tool is movable along the vehicle during a reference run, the movement of the wash tool being manually controllable along at least a partial area of the vehicle, and in that the detected contour of at least the vehicle area in which the movement of the wash tool is controlled manually is storable in the form of contour data on a storage medium and readable therefrom before or during a subsequent washing operation in order to control the vehicle wash facility.

As mentioned at the outset, the reference run may be performed before or during a washing operation. During the reference run, the user may manually control at least one wash tool along at least a partial area of the vehicle. To this end, the vehicle wash facility may have an input device by means of which the user can input control commands suitable for controlling the wash tool. The input device may, for example, comprise a keyboard having a plurality of input keys which can be operated to control the movement of at least one wash tool. Alternatively or additionally, the input device may also for example have a pivoted lever in the manner of a joystick which can be operated to control the movement of at least one wash tool.

The contour of the vehicle can be detected during the reference run. Suitable contour detection methods have already been described above and are known to the person skilled in the art.

The contour the vehicle has in at least the manual control area is stored on a storage medium and may then be used in a subsequent washing operation in order to control the vehicle wash facility. To this end, the contour data is read from the storage medium. To accomplish this, the vehicle wash facility has a suitable data reading device.

Advantageously, the contour of the entire vehicle is storable on the storage medium and readable therefrom for controlling the vehicle wash facility, in particular for controlling the movement of the wash tool. This eliminates the need for re-detecting the contour in a subsequent washing operation.

It is advantageous for the stored contour data to be uniquely assignable to the vehicle, or a class of vehicles, having the stored contour by means of an identification code. Such a configuration is particularly advantageous where a central storage medium is employed, for example in the form of a central database which connects to the vehicle wash facility via a wireless or wired communication channel. It may also be provided for a storage medium to be arranged at the vehicle wash facility so as to be stationary, for example in the form of a read-only memory of a control device of the vehicle wash facility. When, at a later point in time, the user wants to re-clean the vehicle whose contour data of at least the manual control area has been stored or a vehicle having the same contour data, for example a vehicle having the same roof superstructure, the user may then retrieve the assigned contour data from the storage medium by inputting the identification code, so that the data can be used for example to control the movement of at least one wash tool.

In an advantageous embodiment, the storage medium is portable. As has been mentioned before, this makes it possible for the storage medium to be carried along with the vehicle to be cleaned.

It is advantageous for the vehicle wash facility to have a data reading device for touchless reading of the storage medium. By way of example, the storage medium may be read using a radio link. This is advantageous in particular where the storage medium is configured in the form of an RFID tag.

It is particularly advantageous for the vehicle wash facility to have sensors for detecting cleaning process specific data of at least one wash tool and for said cleaning process specific data to be storable on the storage medium and to be readable therefrom for controlling the vehicle wash facility in a subsequent washing operation. Sensors for detecting cleaning process specific data of at least one wash tool may, for example, detect the contact pressure of a rotating wash brush or the cleaning agent consumption of nozzles of a nozzle beam. Such data can be detected automatically during a first washing operation and stored on the storage medium. In a subsequent washing operation, the cleaning process specific data may then be read from the storage medium and used for controlling the vehicle wash facility.

The vehicle wash facility is preferably configured as a gantry-type wash facility.

The following description of a preferred embodiment of the invention, taken in conjunction with the drawings, serves to explain the invention in greater detail.

### BRIEF DESCRIPTION OF THE DRAWINGS

FIG. 1 is a schematic view of a vehicle wash facility shown during a reference run of a wash tool, and

FIG. 2 is a schematic view of the vehicle wash facility of FIG. 1, shown during a subsequent washing operation.

### DETAILED DESCRIPTION OF THE INVENTION

The drawings show a schematic view of a vehicle wash facility 10 in accordance with the invention by means of which a vehicle 12 can be washed. The vehicle wash facility 10 is configured in the form of a gantry-type wash facility and comprises a wash gantry 14 that may be moved back and forth along the vehicle in an advance direction 16. A plurality of wash tools are arranged on the wash gantry 14 in the usual manner. In the illustrated embodiment, a first wash tool is configured in the form of a roof brush 18 which can be driven for rotary movement around a horizontal rotation axis 20 by means of an electric motor 19. Further, two side brushes 22, 24 of identical configuration are used which can be driven for rotary movement around a vertically oriented rotation axis 26 and 28 respectively by means of electric motors 23, 25.

The vehicle wash facility 10 has a control device 30 for controlling the movement of the roof brush 18 and side brushes 22, 24. The control device 30 is electrically connected to an input device 34 via a cable 32. The input device 34 has a keyboard 36 with a plurality of input keys 38. By means of the input keys 38, the user may select a specific wash program and may control the movement of the roof brush 18 and side brushes 22, 24 manually.

The control device 30 comprises a first data reading and data writing device 40 which, in the illustrated embodiment, has an input slot 42 into which a portable storage medium in the form of a magnetic card 44 may be inserted. Alternatively or additionally, the control device may have a second data reading and writing device 41, represented by broken lines in the drawings, which communicates, via a radio link 45, with a storage medium in the form of a transponder 43 positionable in the vehicle 12. The transponder 43 is likewise represented by broken lines in the drawings.

The movement of the roof brush 18 and side brushes 22, 24 along the vehicle 12 is selectively controlled either manually by means of the input keys 38 or automatically by automatic detection of the contour of the vehicle 12 with the aid of sensors. In the illustrated exemplary embodiment, the contour is detected, in a manner known per se, by detecting the motor current of the electric motors 19, 23, 25 of the roof brush 18 and the side brushes 22, 24 together with the position thereof relative to a horizontal and a vertical reference plane respectively. Such contour detection methods are known per se to the person skilled in the art and need not be explained in detail here.

When the vehicle 12 is to be cleaned for a first time by means of the vehicle wash facility 10, the roof brush 18 and side brushes 22, 24 may be moved automatically along the vehicle 12 as a function of the vehicle's contour. It is, however, possible for the user to move the brushes 18, 22, 24 manually at least in partial areas of the vehicle. This will be explained in the following using the roof brush 18 as an example.

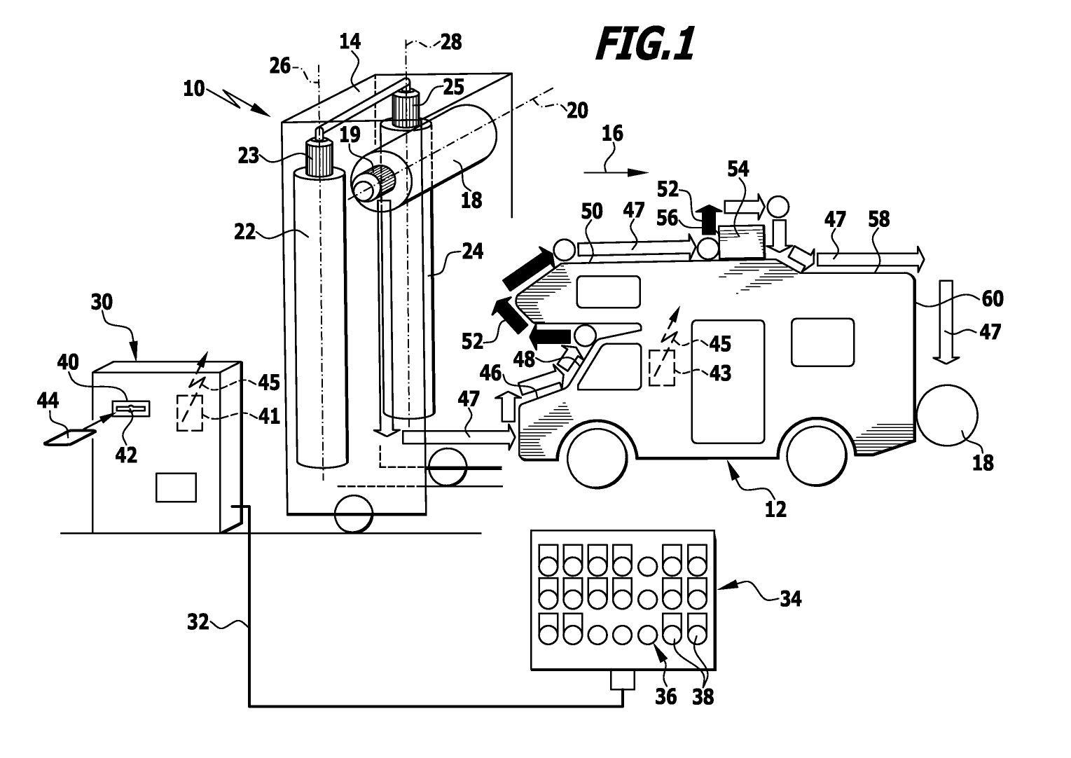

Starting from a parking position illustrated in the drawings, the roof brush is moved automatically in the direction of the light double arrows 47 to the vehicle front end. Thereafter, automatic vehicle contour detection commences, wherein, during a reference run, the movement of the roof brush 18 in the area of the engine hood 46 up to the upper end of the windshield 48 of the vehicle 12 is automatic as a function of the contour of the vehicle. In the adjoining transition area between the windshield 48 and the roof front area 50 of the vehicle 12, the vehicle contour becomes complex. This transition area constitutes a manual control area in which the user controls the movement of the roof brush 18 manually by means of the input keys 38. This is illustrated in FIG. 1 by the dark double arrows 52. In the roof front area 50, the roof brush 18 then moves automatically again, as a function of the (in this area) rectilinear contour of the vehicle 12. In a roof middle area, the vehicle has a superstructure 54. In the area of the front end face edge 56 of the superstructure 54, the user controls the movement of the roof brush 18 manually again by means of the input keys 38, this area constituting another manual control area. In the remaining area of the superstructure 54 as well as in the roof rear area 58 and the vehicle rear 60, the roof brush 18 then moves automatically as a function of the vehicle contour.

The contour data of at least the manual control areas of the vehicle detected during the reference run is stored on the magnetic card 44 and/or transponder 43 and may be used during a subsequent washing operation in order to control the vehicle wash facility 10, in particular to control the movement of the roof brush 18. Thus, the user need not control the roof brush 18 partially manually again in a subsequent washing operation.

Correspondingly, during a reference run, the side brushes 22, 24 can also be controlled in part automatically as a function of the vehicle contour and in part manually with the aid of the input keys 38, and at least the contour data of the manual control areas may be stored on the magnetic card 44 and/or transponder 43 and used in a subsequent washing operation in order to control in particular the movement of the side brushes 22, 24.

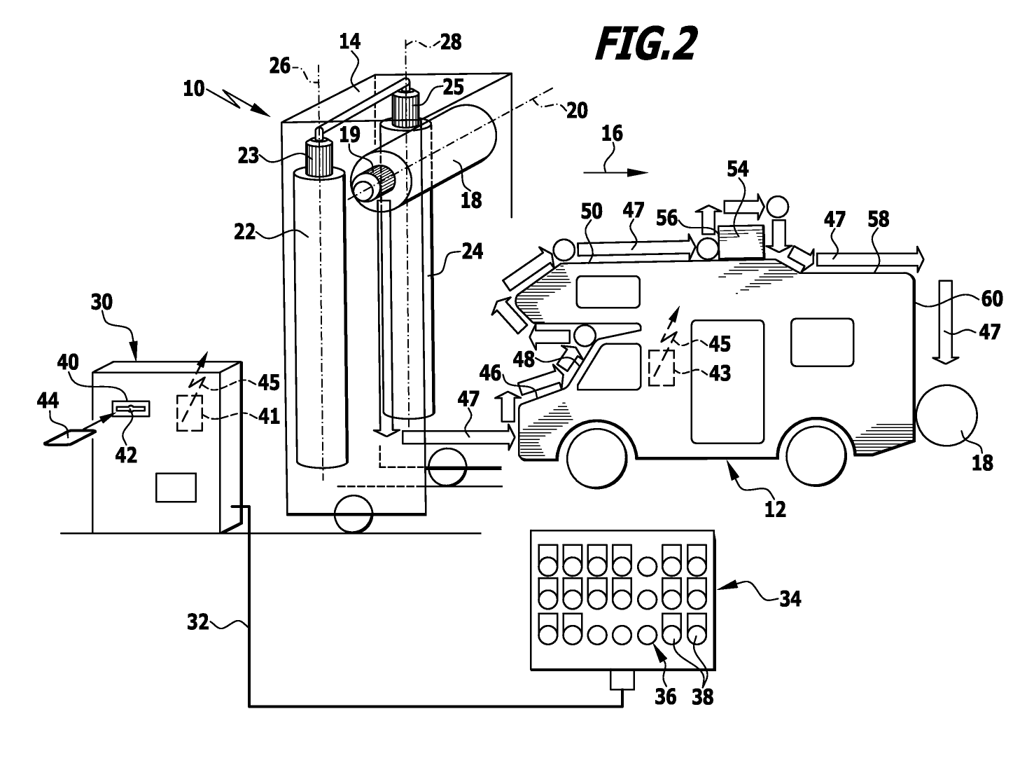

The user can remove the magnetic card 44 from the data reading device 40 and carry it along with the vehicle 12. If, at a later point in time, the vehicle 12 is to be washed again by means of the vehicle wash facility 10, the user may re-insert the magnetic card 44 into the input slot 42 of the data reading device 40. The stored data can then be read and used for controlling the roof brush 18 and the side brushes 22, 24. This is shown in FIG. 2.

During a first washing operation, the user may select a desired wash program using the input device 34 and is also given the option of presetting the speed of the roof brush 18 as well as the side brushes 22, 24 as a function of their position relative to the vehicle 12. In addition, the user may preset the roof brush 18 or the side brushes 22, 24 to make multiple passes, or none at all, across specific vehicle areas. Moreover, the user is given the option of presetting the contact pressure of the roof brush 18 and side brushes 22, 24. These cleaning process specific data are all stored on the magnetic card 44 and/or transponder 43 and are available for controlling the vehicle wash facility 10 in a subsequent washing operation. The subsequent washing operation can therefore be completed within a very short time and with optimal adjustment to the vehicle 12 to be cleaned, without another manual intervention of the user in the control of the vehicle wash facility 10 being necessary.

1. Method for washing a vehicle by means of a vehicle wash facility, wherein at least one wash tool is moved along the vehicle as a function of the contour of the vehicle, wherein at least one wash tool is moved along the vehicle during a reference run, the movement of the wash tool being controlled manually along at least a partial area of the vehicle, and wherein the contour of at least the vehicle area in which the movement of the wash tool is controlled manually is stored in the form of contour data on a storage medium, and wherein the stored contour data is used in a subsequent washing operation in order to control the same vehicle wash facility or a vehicle wash facility of identical construction.

2. Method in accordance with claim 1, wherein the contour of the entire vehicle is stored on the storage medium and used to control the same vehicle wash facility or a vehicle wash facility of identical construction in a subsequent washing operation.

3. Method in accordance with claim 1, wherein, during the reference run, the movement of the wash tool is controlled manually only in a partial area of the vehicle.

4. Method in accordance with claim 1, wherein, during the reference run, the movement of the wash tool is controlled manually along the entire vehicle.

5. Method in accordance with claim 1, wherein the contour data is stored on a portable storage medium.

6. Method in accordance with claim 1, wherein the stored contour data is uniquely assigned to the vehicle, or a class of vehicles, having the stored contour by means of an identification code.

7. Method in accordance with claim 1, wherein the reference run is carried out before a washing operation.

8. Method in accordance with claim 1, wherein the reference run is carried out during a washing operation.

9. Method in accordance with claim 1, wherein cleaning process specific data of at least one wash tool is stored on the storage medium and wherein the stored cleaning process specific data is used in a subsequent washing operation in order to control the same vehicle wash facility or a vehicle wash facility of identical construction.

10. Method in accordance with claim 1, wherein a speed of at least one wash tool relative to the vehicle is detected and wherein the detected speed is stored on the storage medium and wherein the stored speed is used in a subsequent washing operation in order to control the same vehicle wash facility or a vehicle wash facility of identical construction.

11. Vehicle wash facility for carrying out the method in accordance with claim 1, comprising at least one wash tool movable along the vehicle as a function of the contour of the vehicle, wherein at least one wash tool is movable along the vehicle during a reference run, the movement of the wash tool being manually controllable along at least a partial area of the vehicle, and wherein the contour of at least the vehicle area in which the movement of the wash tool is controlled manually is storable in the form of contour data on a storage medium and readable therefrom before or during a subsequent washing operation in order to control the vehicle wash facility.

12. Vehicle wash facility in accordance with claim 11, wherein the contour of the entire vehicle is storable on the storage medium and readable therefrom before or during a subsequent washing operation in order to control the vehicle wash facility.

13. Vehicle wash facility in accordance with claim 11, wherein the stored contour data is uniquely assignable to the vehicle, or a class of vehicles, having the stored contour by means of an identification code.

14. Vehicle wash facility in accordance with claim 11, wherein the storage medium is portable.

15. Vehicle wash facility in accordance with claim 14, wherein the vehicle wash facility has a data reading device for touchless reading the storage medium.

16. Vehicle wash facility in accordance with claim 11, wherein the vehicle wash facility has sensors for detecting cleaning process specific data of at least one wash tool, the data being storable on the storage medium and readable therefrom for controlling the vehicle wash facility.

17. Vehicle wash facility in accordance with claim 11, wherein the vehicle wash facility is configured as a gantry-type wash facility.
